(19) United States
(12) Patent Application Publication
(10) Pub. No.: US 2014/0146543 A1
(43) Pub. Date: May 29, 2014

(54) OUTDOOR LIGHTING DEVICE

(71) Applicant: Magic Lighting Optics, Haifa, IL (US)

(72) Inventor: Meir Ben Levy, Haifa, IL (US)

(73) Assignee: Magic Lighting Optics, Haifa, IL (US)

(21) Appl. No.: 14/082,149

(22) Filed: Nov. 17, 2013

Related U.S. Application Data
(60) Provisional application No. 61/729,637, filed on Nov. 26, 2012.

(51) Int. Cl. F21V 3/04

(52) U.S. Cl. CPC F21V 3/0409
USPC 362/311.01; 29/592.1

(57) ABSTRACT

An outdoor lighting device and method for achieving the same, the device including: (a) a light source; (b) a concentrator including only a first solid optical medium (SOM), the concentrator having an input surface optically coupled to the light source, a side surface and an output surface; and (c) a transparent cover optically coupled to the output surface, and covering substantially all of the output surface, wherein the side surface is shaped so as to provide a desired luminous intensity profile emerging from the transparent cover, and wherein a continuity from the light source to the transparent cover is uninterrupted by an air gap.

This patent application claims priority from and the benefit of U.S. Provisional Patent Application No. 61/729,637, filed Nov. 26, 2012

### FIELD AND BACKGROUND OF THE INVENTION

The present invention relates to lighting devices and, more particularly, to an outdoor lighting device with improved illumination resulting from limiting or eliminating back reflections within the light rays path from the light source to transparent cover sealing the device.

Design of Outdoor lighting imposes high demands on the designer, many of which are not required in other fields of illumination. Moisture and dust necessitate a high quality sealing with a transparent cover. The angular light distribution (luminous intensity) of a streetlight must meet standard requirements such as North America IESNA RP-8-00 or European EN 13201 and CIE140-2000, which requires a high level of uniformity while avoiding Backlight, Uplight and Glare (BUG rating). Furthermore, green and ecological thinking imposes new demands for power conservation, which is a neglected issue in old designs. Modern streetlight devices are generally based on Light Emitting Diodes (LED) for a light source. LED illumination is more efficient in power than the old High Pressure Sodium (HPS) lamps and easier to adapt optics for improved angular distribution of luminous intensity.

An outdoor Light Emitting Diode (LED) lighting device typically includes at least one packaged LED as a light source; at least one free form lens or mirror, to convert the Lambertian luminous intensity distribution typically emitted from the LED source into a rectangular shaped distribution as required for outdoor applications such as streetlight lamps and parking lights; and a transparent cover, to seal the device from dust, moisture and other contaminants. While a freeform lens provides a satisfactory, rectangular shaped illumination, the lens causes high degree of light to be lost due to backward reflections, known as Fresnel reflections, at the surfaces. Fresnel reflections occur in transitions from one medium having refraction index n₁ to another medium with refraction index n₂ which is different from n₁. The reflected light intensity depends on the variation in the refraction index value and the angle of incidence. For example, in transition from air to PMMA (refraction index at approximately 1.5) at 60° incidence angle (which is typically the maximal luminous intensity for street light), the reflections reach 9% of the total incident energy. There are at least four transitions from air to polymer material and vice versa when light passes through the lens and cover, which implies a total loss of light estimated at 25% for an outdoor lamp using free form lens due to Fresnel reflections.

It is known in the art to provide light guides with reflectors for reducing light loss, but all of the known prior art devices have air gaps between the light source and transparent cover.

It would be highly advantageous to have an illumination device where there is no air gap between the light source and the transparent cover of the lighting device. It would be further preferable to have a light guide that is designed to minimize back reflections of light and even more preferable to couple the light source to the transparent cover with a continuous or near-continuous refraction index, avoiding air gaps and thereby, potentially, eliminating back reflection the light emitted from the light source altogether.

### DEFINITIONS

Index of refraction—is the ratio of the velocity of light in a vacuum to that in a medium. The near-continuity of the index of refraction is achieved—in the immediate innovation—by forming or arranging a continuity of optical media without any gaps between the media, or between the light source and transparent cover. That is to say that there is no gas or vacuum in the optical paths. Even if the indices of refraction of the optical media are not all identical, and there still is a small amount of light loss at the interfaces, the loss is still much less than at an interface with air. Accordingly, light propagating from the light source to the transparent cover is uninterrupted by a gap such as an air gap or a vacuum gap.

Solid optical medium (SOM)—is an optical medium of definite shape and volume; not liquid or gaseous and is firm or compact in substance. For example, the first flexible layer between the light source and the concentrator expands and contracts at different temperatures but is neither a liquid nor a gas and conforms to the rest of the definition. A glass concentrator, or one formed from PMMA is also a solid optical medium.

Free-form—denotes a non-standard shape. In the immediate invention, the form of the concentrator is designed to optimize internal reflection and prevent refraction of light out of the concentrator. The concentrator is further designed to provide a desired angular light distribution or luminous intensity profile emerging from the transparent cover. Therefore the concentrator is a free-form concentrator.

Optically coupled—defines a relationship between two media where light goes from one medium to the other (unless prohibited by Snell's law at shallow angles of incidence).

### SUMMARY OF THE INVENTION

There is provided a method and apparatus based on a light guide, to convert Lambertian luminous intensity typically emitted from a LED into a rectangular shape while avoiding high loss of light due to Fresnel reflections. The light guide is designed to transmit light from source to cover with minimal transitions in refraction index and absolutely no transitions from optical material to air, thus minimizing loss of light due to Fresnel reflections.

According to the present invention there is provided an outdoor lighting device, including: (a) a light source; (b) a concentrator including only a first solid optical medium (SOM), the concentrator having an input surface optically coupled to the light source, a side surface and an output surface; and (c) a transparent cover optically coupled to the output surface, and covering substantially all of the output surface, wherein the side surface is shaped so as to provide a desired luminous intensity profile emerging from the transparent cover, and wherein a continuity from the light source to the transparent cover is uninterrupted by a gap.

According to further features in preferred embodiments the device further includes: (d) a first transparent flexible layer of a second SOM, the first layer optically coupling the light source and the concentrator.

According to still further features the device further includes: (d) a first transparent layer of a second SOM, the first layer optically coupling the output surface of the concentrator and the transparent cover.

According to still further features the device further includes: (e) a second transparent flexible layer of a third SOM, the second layer optically coupling the output surface of the concentrator and the transparent cover.

According to still further features the light source is encapsulated in the first transparent flexible layer.

According to still further features the device further includes: (f) a third transparent layer of a fourth SOM, the third layer adhering the first transparent flexible layer to the input surface of the concentrator.

According to still further features the light source is adhered to the input surface of the concentrator via the first transparent flexible layer.

According to still further features the first SOM includes an optical medium selected from the group consisting of: a transparent polymer, a transparent glass material, a transparent silicone material, transparent thermosetting plastic.

According to still further features the second, third and fourth optical media include silicone.

According to still further features a ratio of refraction indices at any interface is between 0.858 and 1.166 and more preferably 0.938 and 1.065.

According to still further features the side surface is a free-form reflector.

According to still further features the concentrator is made from an injection-molded transparent thermoplastic or from a molded transparent silicone such as an injection-molded silicone.

According to still further features the side surface is further shaped so as to effect total internal reflection (TIR) of light emerging from the light source.

According to another embodiment there is provided a method including the steps of: (a) shaping a first solid optical medium (SOM) as a transparent concentrator such that light entering at an input surface of the concentrator is reflected so as to provide a desired luminous intensity profile emerging from an output surface of the concentrator; (b) optically coupling a light source to the input surface of the transparent concentrator; (c) optically coupling a transparent cover to the output surface of the transparent concentrator, covering substantially all of the output surface, such that a continuity of solid optical media from the light source to the transparent cover is uninterrupted by a gap.

According to still further features the transparent concentrator is shaped by injection molding of a thermoplastic material or by molding of silicone (e.g. by injection molding of the silicone).

According to still further features the light source is optically coupled to the input surface of the transparent concentrator by a second transparent flexible SOM.

According to still further features the transparent cover is optically coupled to the output surface of the transparent concentrator via a third transparent flexible SOM.

According to still further features the light source is encapsulated in the second transparent flexible SOM.

According to still further features the encapsulated light source is adhered to the input surface of the concentrator by a fourth transparent SOM.

According to still further features the second transparent flexible SOM is adhered to the input surface of the concentrator.

According to still further features the light source is a Light Emitting Diode.

According to still further features light from the entering at the input surface of the concentrator is totally internally reflected.

### BRIEF DESCRIPTION OF THE DRAWINGS

Various embodiments are herein described, by way of example only, with reference to the accompanying drawings, wherein:

FIG. 1 is a cross-sectional view of an exemplary embodiment of the lighting apparatus of the current invention;

FIG. 2 is a side view of a concentrator of the invention without cross section;

FIG. 3 is a top view of a concentrator of the invention without cross section;

FIG. 4 is a side view of concentrator of a second embodiment of the invention;

FIG. 5 is a top view of concentrator of a second embodiment of the invention;

FIG. 6 is a side view of cross-section A-A of FIG. 5;

FIG. 7 is a basic flow diagram of the inventive process;

FIG. 8 is a second flow chart of a preferred innovative process of the immediate innovation;

FIG. 9 is a third flow chart of a preferred innovative process of the immediate innovation.

### DESCRIPTION OF THE PREFERRED EMBODIMENTS

The principles and operation of a lighting apparatus according to the present invention may be better understood with reference to the drawings and the accompanying description.

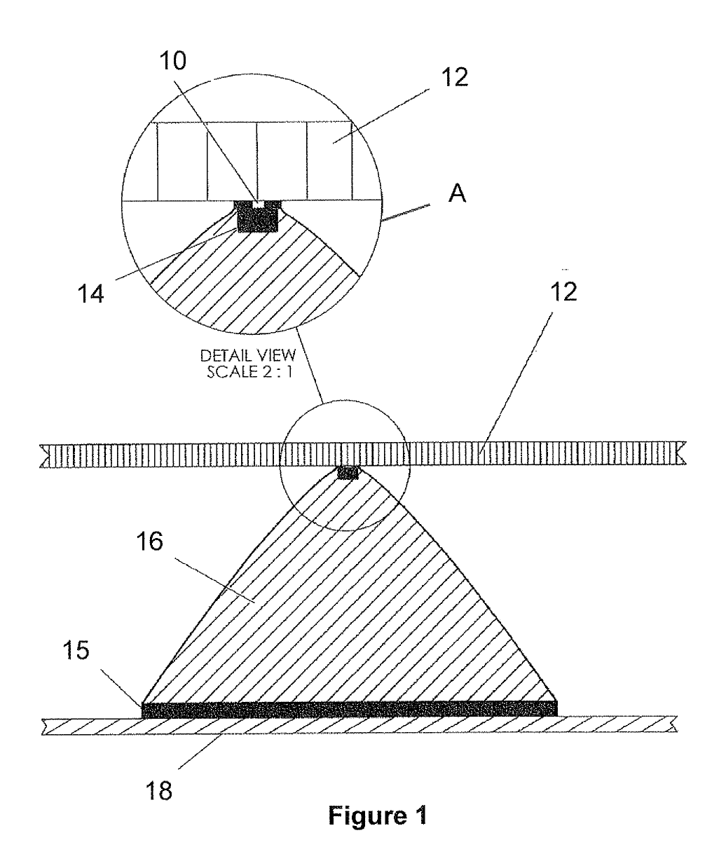

Referring now to the Figures, FIG. 1 depicts a cross-sectional view of an exemplary embodiment of the lighting apparatus of the current invention. Magnified. View A is a magnified section of FIG. 1. An LED 10 is mounted on a Printed Circuit Board (PCB) 12 and coupled to a transparent sealing cover 18 by a light guide. The light guide includes a concentrator 16, a first flexible layer 14 and a second flexible layer 15. Concentrator 16 is adapted to transform Lambertian luminous intensity distribution into a rectangular shape illuminance. Flexible layer 14 adheres LED 10 to concentrator 16. Flexible layer 15 adheres concentrator 16 to transparent cover 18. The light guide transmits light, emitted by LED 10, to the transparent cover 18 and maintains a high level of continuity of refraction index while leaving no air gap between LED 10 and transparent cover 18. The flexible layers 14 and 15 protect the light guide from damage by allowing for displacement due to, among other things, thermal expansion, humidity and impacts. The flexible layers are transparent and do not disturb the continuity of refraction index essential to avoid loss of light. In one embodiment, flexible layer 14 is dome shaped and encapsulates LED 10. It would be most preferable to have an optical medium which creates an index-of-refraction match between the light source and light guide.

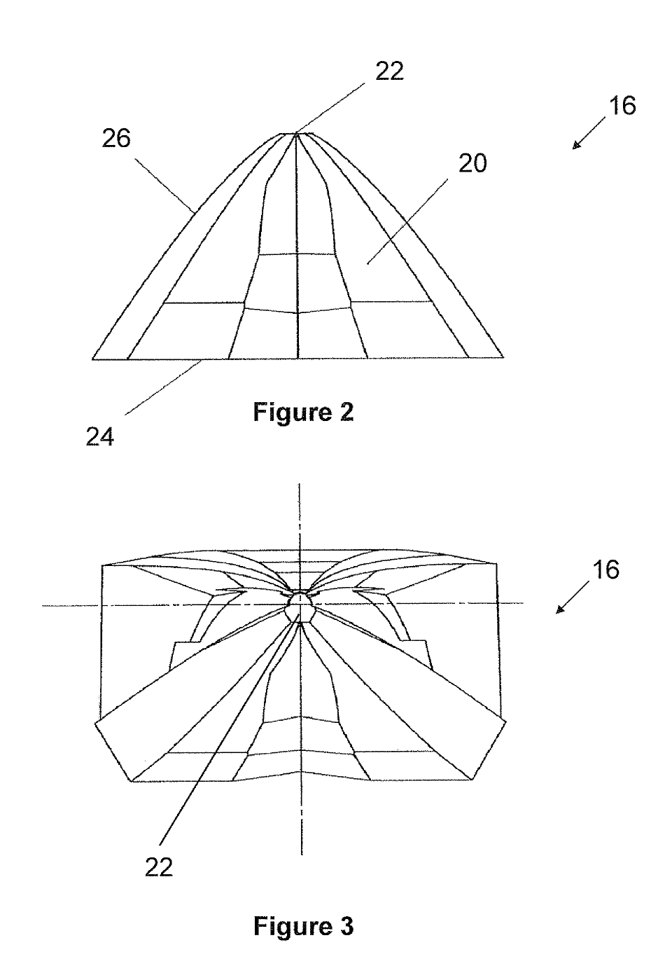

Concentrator 16 can be better understood with reference to FIGS. 2 and 3. FIG. 2 depicts a side view of concentrator 16 without cross section. FIG. 3 depicts a top view of concentrator 16 without cross section. The concentrator has an input surface 22, an output surface 24, and a side surface 20. Light enters the concentrator from the direction of the LED at input surface 22. Light exits the concentrator in the direction of the illumination region (street direction in case of a streetlight) from output surface 24. Light directed into concentrator 16 undergoes Total Internal Reflection (TIR) at side surface 20. That is to say that substantially all the light that enters via the input surface of the concentrator exits via the output surface of the concentrator. Concentrator 16 is made up of a single solid transparent optical medium. The exemplary concentrator is designed to be surrounded (laterally) by air.

The concentrator shown FIG. 2 was designed with ZEMAX™ Part Designer (ZPD) solid software for optical elements. The lines in the side surface 20 of FIG. 2 depict the intersections of surface elements. Each surface element is a mathematical second order parabolic polynomial defined by the optical software ZEMAX as a Compound Parabolic Concentrator (CPC). A CPC is used to concentrate light entering one end of the CPC and exiting at the other end of the CPC. The type of CPC depicted in FIGS. 2 and 3 is the “Basic CPC” as described in detail in “High Collection Nonimaging Optics” by W. T. Welford and R Winston, Academic Press (1989).

Each surface element concentrates light in a specific direction with a specific angular distribution according to the mathematical definition of the CPC element. The concentrator of FIG. 2 was designed with concave side surface elements. The CPC elements closer to input surface 22 reflect light to illuminate the outer frame area of the rectangular region of illumination, while the surface elements closer to output surface 24 reflect light in the direction of the inner part of the illumination region. The number of elements can be increased to better control light distribution and uniformity. Other surface elements including parabolic surface are also possible. It is also possible to form a continuity of the surface, for example by a higher order polynomial that best fits the multiple parabolic elements.

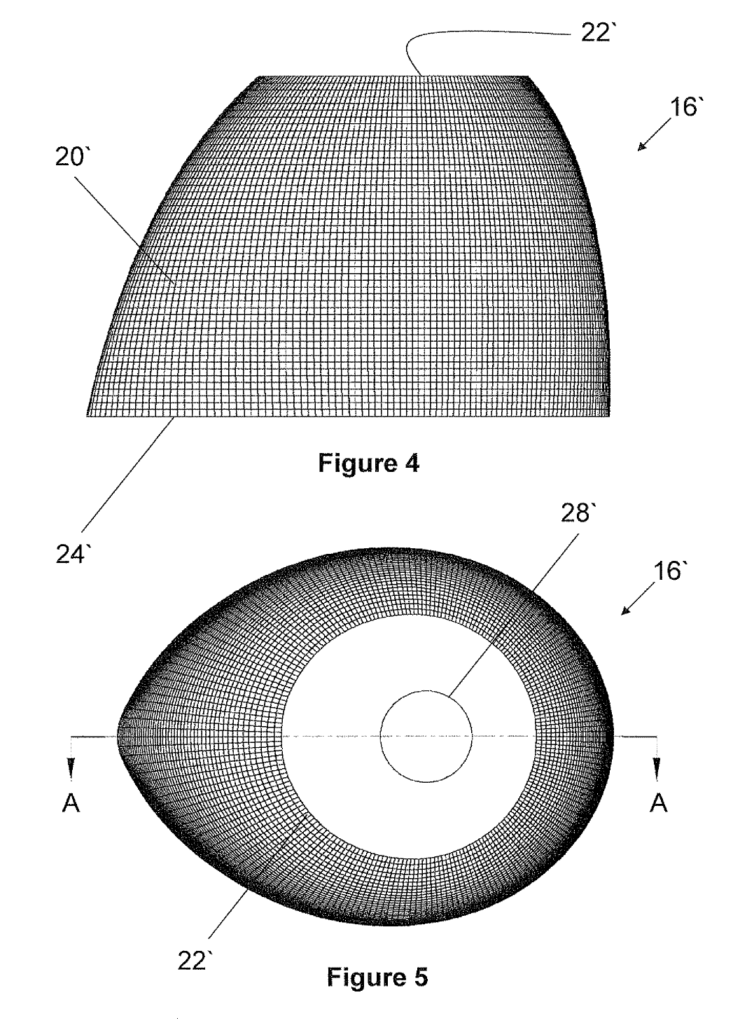

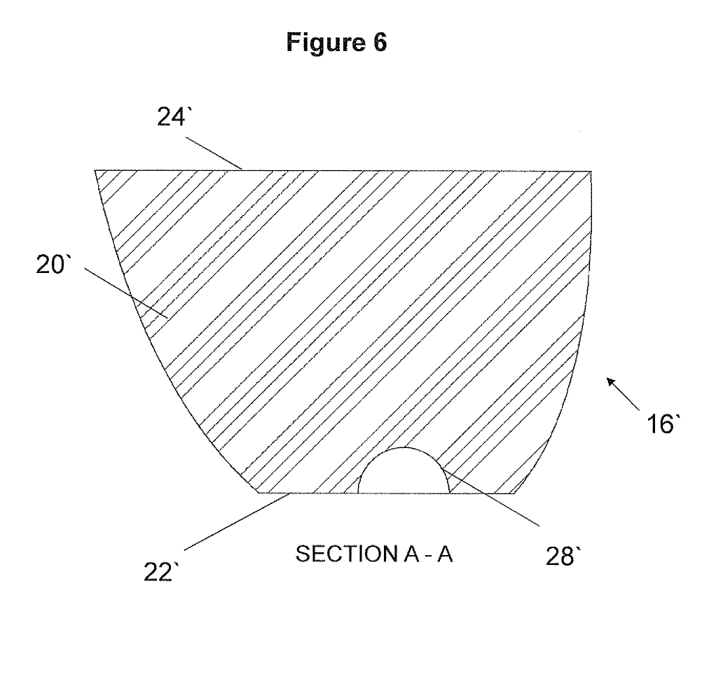

Another possible configuration of the concentrator is shown in FIGS. 4-6. FIG. 4 depicts a side view of concentrator 16′. FIG. 5 is a top view of the input end of concentrator 16′. FIG. 6 is a side view of cross-section A-A of FIG. 5.

In FIGS. 4-6 concentrator 16′ includes an input surface 22′, an output surface 24′, and a free-form side surface 20′. Light enters the concentrator from the direction of the LED at input surface 22′. Light exits the concentrator in the direction of the illumination region (street direction in case of a streetlight) from output surface 24′. Light directed into concentrator 16′ undergoes Total Internal Reflection (TIR) at free-form side surface 20′. Concentrator 16′ is made up of a single solid transparent optical medium. The domed area 28′ is adapted to operationally coupled with the LED light source encapsulated in the flexible layer of transparent SOM.

Materials and Processes

At each interface between one optical medium and a second optical medium, there is generally a refraction and back reflection of light. How much light is back reflected depends on the ratio of indices of the two interfacing media. If the indices are close together the amount of light minimal. If the indices are further apart then the amount of refracted light at the interface is greater.

For example, the index of refraction of air is 1.00029 at 1 atmosphere and 0° C., whereas the refraction index of PMMA is about 1.4893-1.4914; the difference between the two optical media is significant, causing a relatively high degree of refraction at the interface. On the other hand, the refraction index of silicone can be between 1.40-1.42—an index much closer to that of PMMA. Silicone polymers can be engineered or synthesized to increase the refraction index to 1.50 or more. Different types of glass have different indices of refraction. For example, acrylic glass has a refraction index (RI) between 1.490-1.492, crown glass has an RI between 1.50-1.54 and flint glass has an RI between 1.60-1.62—to name just a few types of glass.

Therefore, by providing an uninterrupted continuum of optical media that do not include air, the refraction indices can be matched as closely as possible to provide a near-continuous index of refraction from the light source to an output surface of the concentrator. More precisely, it is preferable that at each interface between optical media, the ratio of refractive indices of the interfacing media should be between 0.8588 and 1.166. That is to say that an optical medium with an index of refraction of 1.40 should not interface with an optical medium that has an index of refraction greater than 1.63 (pure flint glass has an RI of up to 1.62). The optical medium should be solid (e.g. flexible silicone, PMMA, glass etc.).

Ideally, the concentrator is formed as a single medium with the light source, such as an LED, bonded into the concentrator at an input end, without contaminants or air gaps. The result is a continuous index of refraction from light source to output.

Due to manufacturing considerations, it is more convenient, and practically implementable, to acquire an encapsulated. LED (or other light source) which is encapsulated in an SOM, usually silicone. The silicone encapsulated LEDs are commercially available, and generally have a domed appearance. The elasticity and flex of the silicone differs based on the exact polymers used in the process. In preferred embodiments, the silicone can be synthesized to match, as closely as possible, the index of refraction of the concentrator, whether it be made of PMMA, glass, some transparent thermoplastic material, or some other transparent SOM.

In the case of an encapsulated LED, the encapsulated light source is preferably adhered to the concentrator by a second silicone layer which adheres abutting surfaces as it polymerizes. In other embodiments the encapsulated LED is positioned abutting the concentrator and fixed in place through mechanical pressure during assembly. In this manner, one less layer of optical medium is needed in the final assembly, and still no air gaps are present between the optical media.

A further consideration is the transparent light cover. Once again, in an ideal situation, the cover is in direct optical contact with the concentrator with neither air gaps nor additional intervening layer of adherent. This ideal or optimal state can be achieved in at least two ways: in the first option, the transparent cover is adhered to the concentrator during the concentrator's polymerizing process. This is possible, if logistically difficult, when using an injection molding process with transparent silicone rubber, or molding the cover and concentrator together with the mold during the injection process of molded PMMA. The second option is to position the cover abutting the concentrator and mechanically pressing the components together during the assembly process, before sealing the lighting device. The pressure ensures that there are no air gaps between the concentrator and cover, and obviates the need for an adherent.

In an alternative process, a more logistically practical and convenient process is offered. In the alternative process, a transparent layer of flexible SOM, which acts as an adherent, is applied to the output surface of the concentrator and/or to the transparent cover. The two surfaces are adhered together by the flexible layer, preferably having a refraction index similar to that of the concentrator and/or cover. In this manner, the near-continuity of index of refraction from light source to concentrator output surface, and/or transparent cover, is preserved. In one preferred embodiment, the SOM of flexible layers 14 and 15 is silicone. In other embodiments, the SOM of flexible layers 14 and 15 is a transparent flexible polymer other than silicone.

Silicone is easily molded, transparent and flexible when it expands under heat. In one preferred process, silicone is inserted into a dome-shaped mold and the LED is embedded into the exposed surface of silicone before it dries, so that when the silicone polymerizes the LED is encapsulated in an air-tight manner, in the SOM.

In one preferred embodiment, the SOM of concentrator 16/16′ is glass. In a more preferred embodiment, the SOM is a PMMA polymer. There is some degree of difficulty in molding the shapes depicted in FIGS. 4-9 from PMMA. Furthermore, PMMA takes about twenty minutes to cool which creates a slow production process. In an even more preferred embodiment, the SOM is silicone. The concentrator can be formed from injection molded silicone. Silicone, such as Dow Corning MS-1002 or 1003, can easily be molded to any desired shape and size. In this case, additional flexible layers are unnecessary.

The flexible silicone layers have similar indices of refraction to the other optical media present. In some embodiments, the silicone can be synthesized to have matching indices of refraction. In other embodiments, the flexible layers and harder/stiffer (having a higher elastic modulus) concentrator have slightly different indices of refraction. In a preferred process, the concentrator can serve as a mold for flexible layer 14. In the process, liquid silicone is poured into dome shaped indentation 28′ and the LED mounted on a PCB is immersed in the exposed surface of liquid silicone. The silicone is allowed to polymerize, simultaneously encapsulating the LED in the SOM (without any air gaps or contaminants between the LED and the silicone) and adhering the flexible silicone layer (encapsulant) to the injection molded silicone, PMMA, glass or other concentrator.

In further steps the concentrator is adhered to the transparent cover 18 without any air gaps between the concentrator and the cover (either using a flexible layer of silicone or under pressure during assembly). The result is that the optical media intervening between the LED light source and transparent cover for a continuity of optical media which is uninterrupted by any gas such as air. One skilled in the art would be able to find alternative materials for each of the aforementioned. Alternative materials may be selected from other transparent optical materials.

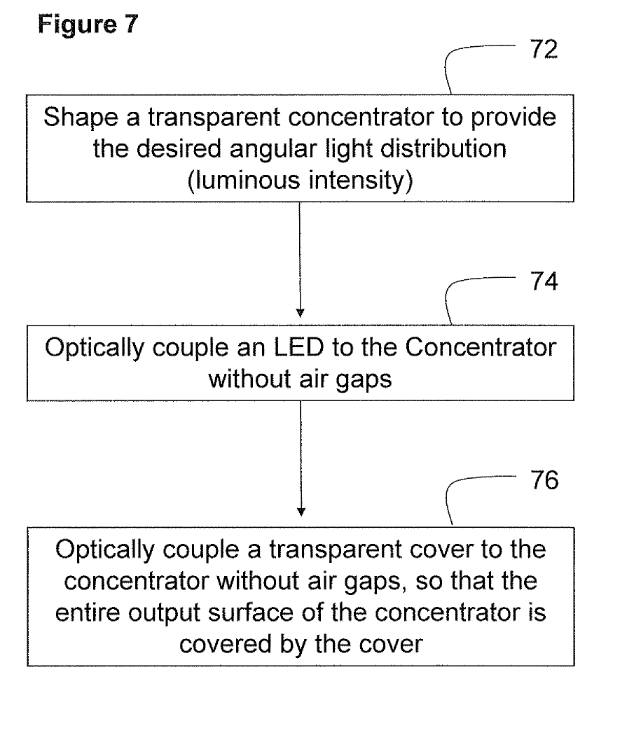

Referring now to FIG. 7, the Figure depicts a basic flow diagram of the inventive process. In step 72 a transparent concentrator is shaped to provide a desired angular light distribution (luminous intensity) for an outdoor illumination device. The luminous intensity can be dictated by recommended standards such as, for example, North America IESNA RP-8-00 or European EN 13201, CIE140-2000 etc. Preferably, the concentrator is shaped so that all the light entering the concentrator at an input surface exits at an output surface (i.e. effecting total internal reflection).

In step 74 a light source, such as an LED, is optically coupled to the concentrator without any air gaps in between the LED and the concentrator.

In step 76 the concentrator is optically coupled to a transparent cover which seals the device and prevents moisture and other contaminants from entering the device. No gaps (of air, gas, fluid, or a vacuum) are allowed between the concentrator and the transparent cover.

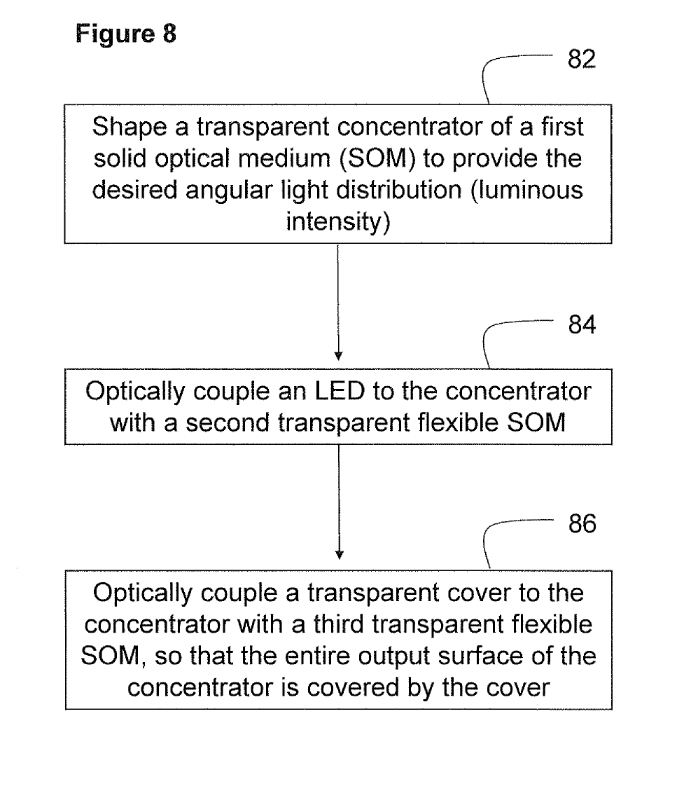

Referring now to FIG. 8, the Figure depicts a second flow chart of a preferred innovative process of the immediate innovation. In step 82 a transparent concentrator is shaped including a first SOM, to provide a desired angular light distribution (luminous intensity) for an outdoor illumination device. Preferably, the concentrator is shaped so that all the light entering the concentrator at an input surface exits at an output surface (i.e. effecting total internal reflection). In some embodiments the first SOM is a thermoplastic material which is shaped by injection molding (or other means). In other embodiments the first SOM is a thermosetting material or polymer which is shaped by a molding process (e.g. injection molding).

In step 84 a light source (e.g. a light emitting diode) is optically coupled to the concentrator via a second transparent flexible SOM. The second SOM optically couples the LED to the concentrator (e.g. by adhesion) without any gap (gas, liquid, vacuum) between the two.

In step 86 a transparent cover is optically coupled to the concentrator by a third transparent flexible SOM. The transparent cover covers the entire output surface of the concentrator. The transparent cover seals the illumination device. In some embodiments the second and third SOM both include silicone.

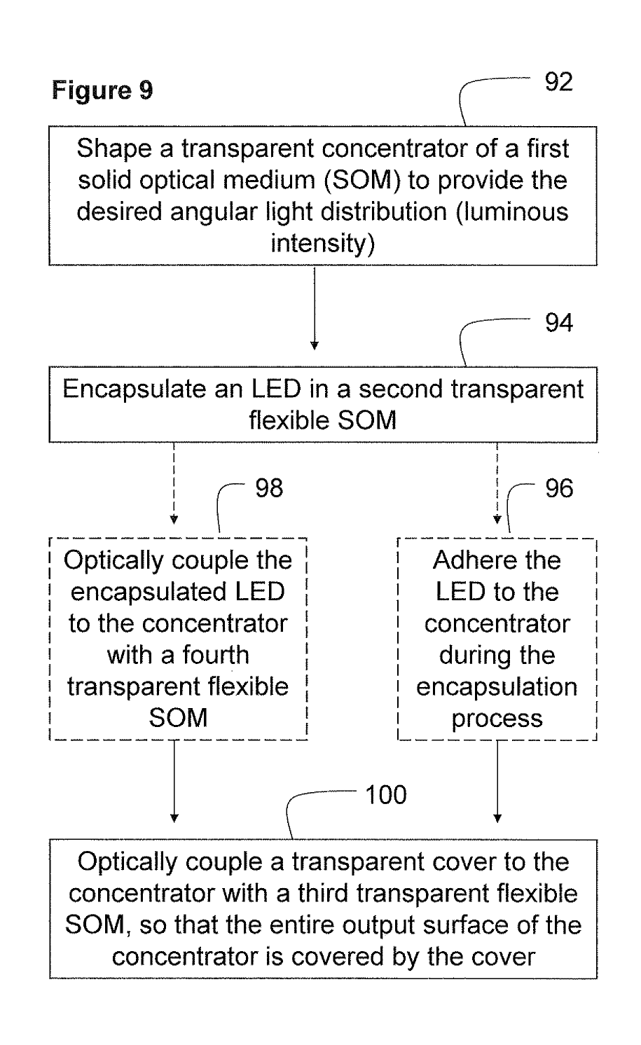

Referring now to FIG. 9, the Figure depicts a third flow chart. In step 92 a transparent concentrator is shaped including a first SOM, to provide a desired angular light distribution (luminous intensity) for an outdoor illumination device. Preferably, the concentrator is shaped so that all the light entering the concentrator at an input surface exits at an output surface (i.e. effecting total internal reflection).

In step 94 a light source, such as an LED, is encapsulated in a second transparent flexible SOM.

In one embodiment of the innovative process, shown in step 96, the LED is adhered to the concentrator during the encapsulation process. In another embodiment of the innovative process, shown in step 98, the encapsulated LED is optically coupled to the concentrator with a fourth transparent flexible SOM as an intervening optical medium. In other embodiments the encapsulated LED is optically coupled to the concentrator by mechanical pressure.

In step 100 the concentrator is optically coupled to a transparent cover by a third transparent flexible SOM as an intervening optical medium. In other embodiments of the process, the concentrator is optically coupled to the cover by mechanical pressure. The transparent cover seals the illumination device. In some embodiments the second, third and fourth SOM all include silicone.

One of ordinary skill in the art is able design the light guide of the present invention with a ray tracing program such as ray tracing software developed by ZEMAX. Software such as Solid Works™ or Inventor Auto CAD™ can be used to create a design of the desired shape of the concentrator based on the results of the ray tracing program. Alternatively or additionally MATLAB™ software can be used to design the desired optimal shape of the free-form reflector. MATLAB™ software includes an optimization toolbox with a large variety of optimization algorithms.

Silicone

Silicone-based materials are prevalently used as encapsulants and lenses in a variety of LED device designs. The key attributes of silicones that make them attractive materials for high-brightness (HB) LEDs include their high transparency in the UV-visible region, controlled refractive index (RI), and stable thermo-opto-mechanical properties.

Silicones are finding wide applicability as packaging materials for HBLEDs. The silicone polymers can be synthesized as a linear polymer with varying organic groups attached to the silicon atom; this group tailors the refractive index. Silicones are also highly transparent in the UV-visible wavelength region. With minimal to no absorption or scattering losses, light that is produced by the LED is transmitted efficiently through the silicone material.

Silicones can also be formulated to achieve a wide range of cured modulus values. The hardness can range from soft compliant gels, to harder yet flexible elastomers, up to very hard resinous materials. The cured modulus is dictated by two factors: the crosslink density and the ratio of linear to branched silicon species in the polymer.

When compliant gels and soft elastomers are used to encapsulate devices, they provide a soft, stress-relieving character that can cushion the devices from internal and external stresses. A critical characteristic of a good encapsulant is adhesion, and silicones can be designed to have good adhesion to the various substrates and components used to build LEDs

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An outdoor lighting device, comprising:
(a) a light source;
(b) a concentrator including only a first solid optical medium (SOM), said concentrator having an input surface optically coupled to the light source, a side surface and an output surface; and
(c) a transparent cover optically coupled to said output surface, and covering substantially all of said output surface, wherein said side surface is shaped so as to provide a desired luminous intensity profile emerging from said transparent cover, and wherein a continuity from said light source to said transparent cover is uninterrupted by a gap.

2. The outdoor lighting device of claim 1, further comprising:
(d) a first transparent flexible layer of a second SOM, said first layer optically coupling said light source and said concentrator.

3. The outdoor lighting device of claim 1, further comprising:
(d) a first transparent layer of a second SOM, said first layer optically coupling said output surface of said concentrator and said transparent cover.

4. The outdoor lighting device of claim 2, further comprising:
(e) a second transparent flexible layer of a third SOM, said second layer optically coupling said output surface of said concentrator and said transparent cover.

5. The outdoor lighting device of claim 4, wherein said light source is encapsulated in said first transparent flexible layer.

6. The outdoor lighting device of claim 5, further comprising:
(f) a third transparent layer of a fourth SOM, said third layer adhering said first transparent flexible layer to said input surface of said concentrator.

7. The outdoor lighting device of claim 2, wherein said light source is adhered to said input surface of said concentrator via said first transparent flexible layer.

8. The outdoor lighting device of claim 1, wherein said first SOM includes an optical medium selected from the group consisting of: a transparent polymer, a transparent glass material, a transparent silicone material, transparent thermosetting plastic.

9. The outdoor lighting device of claim 6, wherein said second, third and fourth optical media include silicone.

10. The outdoor lighting device of claim 9, wherein a ratio of refraction indices at any interface is between about 0.858 and about 1.166.

11. The outdoor lighting device of claim 9, wherein a ratio of refraction indices at any interface is between about 0.938 and about 1.065.

12. The outdoor lighting device of claim 1, wherein said side surface is a free-form reflector.

13. The outdoor lighting device of claim 1, wherein said concentrator is made from an injection-molded transparent thermoplastic.

14. The outdoor lighting device of claim 1, wherein said concentrator is made from a molded transparent silicone.

15. The outdoor lighting device of claim 1, wherein said side surface is further shaped so as to effect total internal reflection (TIR) of light emerging from said light source.

16. A method comprising the steps of:
(a) shaping a first solid optical medium (SOM) as a transparent concentrator such that light entering at an input surface of said concentrator is reflected so as to provide a desired luminous intensity profile emerging from an output surface of said concentrator;
(b) optically coupling a light source to said input surface of said transparent concentrator;
(c) optically coupling a transparent cover to said output surface of said transparent concentrator, covering substantially all of said output surface, such that a continuity of solid optical media from said light source to said transparent cover is uninterrupted by a gap.

17. The method of claim 16, wherein said transparent concentrator is shaped by injection molding of a thermoplastic material.

18. The method of claim 17, wherein said transparent concentrator is shaped by molding of silicone.

19. The method of claim 16, wherein said light source is optically coupled to said input surface of said transparent concentrator by a second transparent flexible SOM.

20. The method of claim 19, wherein said transparent cover is optically coupled to said output surface of said transparent concentrator via a third transparent flexible SOM.

21. The method of claim 20, wherein said light source is encapsulated in said second transparent flexible SOM.

22. The method of claim 21, wherein said encapsulated light source is adhered to said input surface of said concentrator by a fourth transparent SOM.

23. The method of claim 21, wherein said second transparent flexible SOM is adhered to said input surface of said concentrator.

24. The method of claim 16, wherein said light source is a Light Emitting Diode.

25. The method of claim 16, wherein light from said entering at said input surface of said concentrator is totally internally reflected.
